(19) United States
(12) Patent Application Publication
(10) Pub. No.: US 2014/0108619 A1
(43) Pub. Date: Apr. 17, 2014

(54) INFORMATION PROVIDING SYSTEM AND METHOD FOR PROVIDING INFORMATION

(71) Applicant: FUJITSU LIMITED, Kawasaki-shi (JP)

(72) Inventors: Kensuke KURAKI, Ichikawa (JP); Taizo ANAN, Kawasaki (JP)

(73) Assignee: FUJITSU LIMITED, Kawasaki-shi (JP)

(21) Appl. No.: 14/023,046

(22) Filed: Sep. 10, 2013

(30) Foreign Application Priority Data
Oct. 15, 2012 (JP) 2012-228467

(51) Int. Cl. H04L 29/08

(52) U.S. Cl. CPC H04L 67/10
USPC 709/219; 709/217

(57) ABSTRACT

An information providing system includes: a first device including a first memory and a first processor coupled to the first memory and configured to: transmit information regarding registered information registered in a server using user identification information for identifying a user, and receive information to be provided; and a second device including a second memory and a second processor coupled to the second memory and configured to: generate the information to be provided on the basis of the information regarding the registered information received from the first device, and transmit the information to be provided to the first device.

### CROSS-REFERENCE TO RELATED APPLICATION

This application is based upon and claims the benefit of priority from the prior Japanese Patent Application No. 2012-228467, filed on Oct. 15, 2012, the entire contents of which are incorporated herein by reference.

### FIELD

The embodiments discussed herein are related to a technique for providing information for a user and a technique for receiving information.

### BACKGROUND

In these years, in a service that provides information, information selected in accordance with the profile and the tastes of a user who is to receive the information is provided.

For example, there is a technique for assigning one or a plurality of advertisements on the basis of information regarding tastes and likings registered by a user by filling in an input form. The technique is disclosed in Japanese Laid-open Patent Publication No. 2002-092022, for example. When the user is to access a web page, the content of files of the assigned advertisements is incorporated into at least one file configuring the web page and transmitted to the user.

In addition, information regarding attributes registered by the user by filling in the input form is held by a terminal used by the user. There is also a technique for displaying only an advertisement that is likely to attract the user's attention by determining whether or not each of the homepage advertisements received from a server matches the information regarding the attributes of the user. The technique is disclosed in Japanese Laid-open Patent Publication No. 2002-297619, for example.

### SUMMARY

According to an aspect of the invention, an information providing system includes: a first device including a first memory and a first processor coupled to the first memory and configured to: transmit information regarding registered information registered in a server using user identification information for identifying a user, and receive information to be provided; and a second device including a second memory and a second processor coupled to the second memory and configured to: generate the information to be provided on the basis of the information regarding the registered information received from the first device, and transmit the information to be provided to the first device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information providing system according to an embodiment;

FIG. 2 is a sequence diagram illustrating a procedure beginning with a request to process content made by an advertiser terminal 5 and ending with returning of the content to which an identifier has been added to an advertiser;

FIG. 3 is a sequence diagram illustrating a procedure beginning with a request to provide information made by a user terminal 1 and ending with transmission of information to be provided to the user terminal 1;

FIG. 4 is a functional block diagram illustrating the user terminal 1 and an information providing server 2;

FIG. 5 is a diagram illustrating an image at a time when registered information is displayed;

FIG. 6 is a diagram illustrating an example of the data structure of a login information storage unit 15;

FIG. 7 is a diagram illustrating an example of the data structure of a relevant information storage unit 25;

FIG. 8 is a diagram illustrating an example of the data structure of a management information storage unit 26;

FIG. 9 is a diagram illustrating an example of the data structure of a user information request;

FIG. 10 is a flowchart illustrating a reception process performed by a reception device and a flowchart illustrating a transmission process performed by a transmission device;

FIG. 11 is a flowchart illustrating a process for generating user information;

FIG. 12 is a diagram illustrating an example of the user information;

FIG. 13 is a flowchart illustrating process for generating information to be provided;

FIG. 14 is a diagram illustrating an information providing system according to another embodiment;

FIG. 15 is a sequence diagram illustrating a procedure beginning with a request to provide information made by a user terminal 7 and ending with transmission of information to be provided to the user terminal 7 according to the other embodiment;

FIG. 16 is a functional block diagram illustrating the user terminal 7 and an information collecting server 8;

FIG. 17 illustrates an example of the data structure of a history information storage unit 84;

FIG. 18 is flowcharts illustrating a transmission process performed by a transmission device, a reception process performed by a reception device, and processing performed by the information collecting server according to the other embodiment;

FIG. 19 is a flowchart illustrating a process for generating user information according to the other embodiment;

FIG. 20 is a diagram illustrating the hardware configuration of a wireless terminal 100 that functions as a reception device; and

FIG. 21 is a diagram illustrating an example of the hardware configuration of a computer 200 that functions as a transmission device or the information collecting server 8.

### DESCRIPTION OF EMBODIMENTS

Not only in the case of advertisements displayed on web pages but also in various other forms, a user may be provided with an opportunity to obtain interesting information by providing information according to the profile and the tastes of the user. Furthermore, when information is provided by a company, the information may be more effectively delivered to a client who is expected to be interested in the information.

In the techniques disclosed in patent literatures 1 and 2, however, information regarding the profile and the tastes of a user is generated by the user by filling in the input form. That is, the user is supposed to fill in the input form in advance in order to use a service.

Therefore, an object of the technique disclosed in the embodiments is, in a technique for providing information according to a user, to generate user information regarding the profile and the tastes of the user without requesting the user to input information.

Embodiments will be described in detail hereinafter with reference to the accompanying drawings.

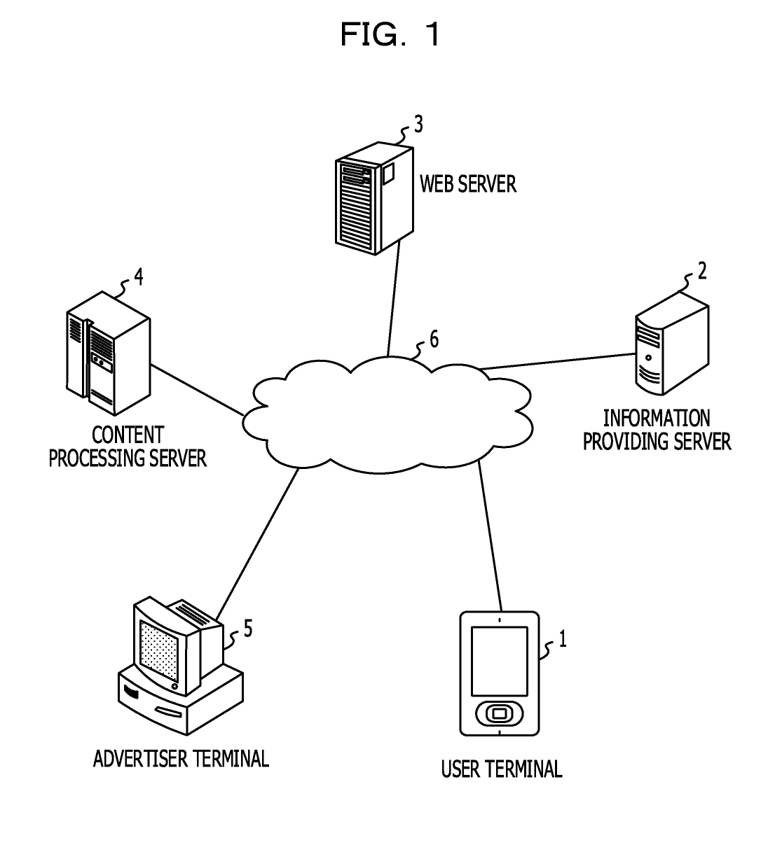

FIG. 1 is a diagram illustrating an information providing system according to an embodiment. The information providing system includes at least a transmission device that transmits information to be provided and a reception device that receives provided information. In this embodiment, an information providing server 2 will be taken as an example of the transmission device. A user terminal 1 will be taken as an example of the reception device.

The user terminal 1 registers information in a web server 3 using an account of a user. The information registered in the web server 3 using the account of a user will be referred to as registered information. The web server 3 manages the registered information. In this embodiment, the web server 3 is a device that provides a social networking service (SNS).

When a user desires to use a service such as an SNS, the user creates his/her own account. In general, the user registers information regarding his/her profile when creating an account. Therefore, the web server 3 stores the information regarding the profile as part of the registered information. Furthermore, in a service such as an SNS, the user may post an article using his/her own account. Therefore, the web server 3 accumulates the posted information as part of the registered information.

In this embodiment, the user terminal 1 obtains the registered information from the web server 3 and transmits information regarding the registered information to the information providing server 2. The information providing server 2 then generates information to be provided for the user terminal 1 on the basis of the information regarding the registered information. The information regarding the registered information may be, for example, the registered information itself, user information regarding the profile and the tastes of the user, or the like.

More specifically, the user terminal 1 transmits the registered information obtained from the web server 3 to the information providing server 2. In this case, at least part of the registered information is transmitted to the information providing server 2 as the information regarding the registered information. The information providing server 2 extracts the user information regarding the profile and the tastes from the registered information.

The information providing server 2 then generates the information to be provided for the user terminal 1 on the basis of the user information. The information providing server 2 selects relevant information that is likely to match the profile and the tastes of the user, and provides the relevant information as the information to be provided. The relevant information is information regarding content, that is, for example, a uniform resource locator (URL) of a product website relating to an advertisement or the like.

On the other hand, the user terminal 1 may extract the user information regarding the profile and the tastes from the registered information obtained from the web server 3. In this case, the user information is transmitted to the information providing server 2 as the information regarding the registered information. The information providing server 2 then generates the information to be provided for the user terminal 1 on the basis of the received user information.

In this embodiment, an example in which the information regarding the registered information is the user information, that is, the latter case, will be described, but the technique disclosed herein may also be realized in the former case.

The information providing system may further include a content processing server 4 in addition to the transmission device and the reception device. The content processing server 4 is a device that adds information to content including at least one image. More specifically, the content processing server 4 applies a digital watermarking technique for embedding information in the content or a technique for adding a Quick Response (QR) code (registered trademark) indicating information to content.

In addition, in this embodiment, content is an advertising image or a commercial image, and transmitted from an advertiser terminal 5 to the content processing server 4. The information to be added is an identifier specified by the information providing server 2. The identifier is information for uniquely identifying content.

The advertiser terminal 5 is a device that requests addition of information to content. The advertiser terminal 5 registers, in the information providing server 2 through the content processing server 4, a plurality of pieces of relevant information and condition information regarding conditions under which each of the plurality of pieces of relevant information is selected. Details of the condition information will be described later.

The user terminal 1, the information providing server 2, the web server 3, the content processing server 4, and the advertiser terminal 5 are connected to one another by a general network 6 such as the Internet, a local area network (LAN), or a wide area network (WAN). Some of the user terminal 1, the information providing server 2, the web server 3, the content processing server 4, and the advertiser terminal 5 may be connected to one another by a dedicated network.

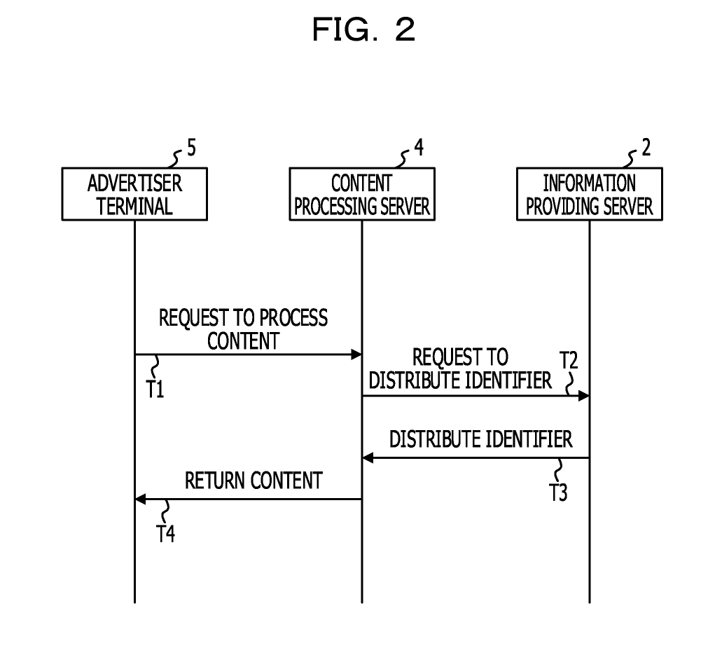

Next, a procedure beginning with a request to process content made by the advertiser terminal 5 and ending with returning of the content to which an identifier has been added to an advertiser will be described with reference to FIG. 2. FIG. 2 is a sequence diagram illustrating the procedure beginning with a request to process content made by the advertiser terminal 5 and ending with returning of the content to which an identifier has been added to an advertiser.

First, the advertiser terminal 5 transmits a request to process content to the content processing server 4 (T1). The request to process content includes the content, a plurality of pieces of relevant information, and condition information for selecting a user for whom each of the plurality of pieces of relevant information is to be provided. The condition information is information including at least one combination between an item name and an item value, and is information for identifying one of the plurality of pieces of relevant information.

For example, when a URL “http://fjclothes.com/m0010/” is to be provided as relevant information, a manager who is operating the advertiser terminal 5 inputs condition information including a combination between an item name “gender” and an item value “male”, a combination between an item name “age” and an item value “0 to 10 years old”, and a combination between an item name “favorite color” and an item value “white”. The advertiser terminal 5 transmits the condition information corresponding to each of the plurality of pieces of relevant information to the content processing server 4.

The content processing server 4 requests the information providing server 2 to distribute an identifier to be added to the content (T2). The request to distribute an identifier includes the plurality of pieces of relevant information and the condition information for each of the plurality of pieces of relevant information. The request may further include the name of the content.

The information providing server 2 stores the received information in a relevant information storage unit 25 thereof. The relevant information storage unit 25 will be described later. The information providing server 2 then generates a unique identifier for the content, and distributes the identifier to the content processing server 4 (T3).

The content processing server 4 adds the received identifier to the content. The content processing server 4 then returns the content to which the identifier has been added to the advertiser terminal 5 (T4). In this embodiment, the content processing server 4 performs a process for embedding the identifier in the content. For example, the content processing server 4 uses the technique disclosed in Japanese Laid-open Patent Publication No. 2004-349879, Japanese Laid-open Patent Publication No. 2007-67629, or Japanese Laid-open Patent Publication No. 2012-142741.

After the information is added to the content as described above, the advertiser transmits the content to a company who delivers the content. Thereafter, for example, the company delivers the content, and the user browses the delivered content. If the user desires to obtain information regarding content he/she is interested in, the user uses the user terminal 1 to request the information providing server 2 to provide the information.

Here, the user captures an image of the content using a camera of the user terminal 1. The user terminal 1 may execute a technique for extracting an identifier corresponding to the technique for embedding an identifier used by the content processing server 4. That is, the user activates an application for extracting an identifier and captures the image of the content. The user terminal 1 then executes a particular algorithm for extracting an identifier from the content in which the identifier has been embedded. As a technique for extracting embedded information from content such as an image, the technique disclosed in Japanese Laid-open Patent Publication No. 2004-349879, Japanese Laid-open Patent Publication No. 2007-67629, or Japanese Laid-open Patent Publication No. 2012-142741 may be used.

For example, when the content is a commercial video, the commercial video is transmitted to a broadcast station. Thereafter, the commercial video broadcast by the broadcast station is captured by the user using the user terminal 1. As described above, the user terminal 1 performs the process for extracting an identifier from at least one captured image.

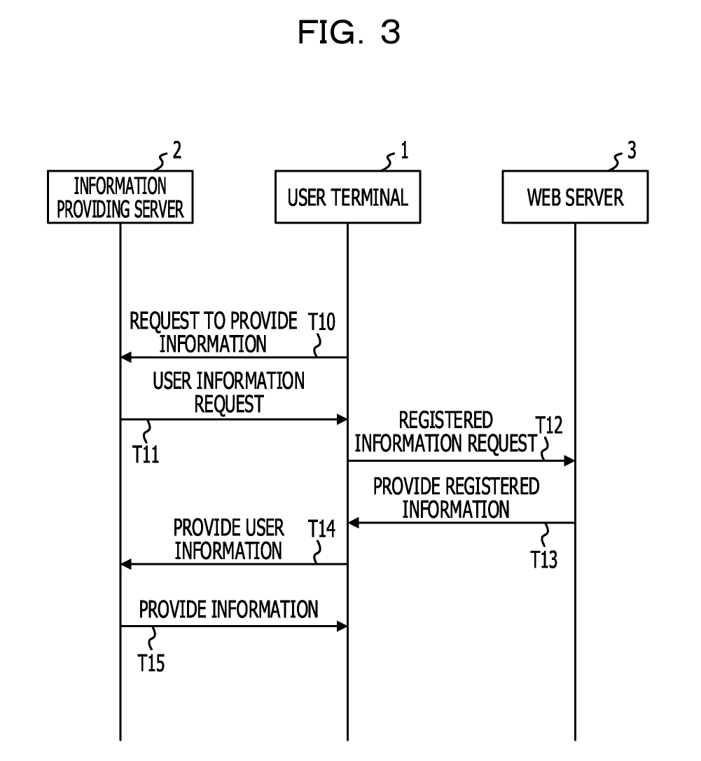

A procedure beginning with a request to provide information made by the user terminal 1 and ending with transmission of information to be provided to the user terminal 1 will be described hereinafter. FIG. 3 is a sequence diagram illustrating the procedure beginning with a request to provide information made by the user terminal 1 and ending with transmission of information to be provided to the user terminal 1.

First, the user terminal 1 transmits a request to provide information to the information providing server 2 (T10). The request to provide information is information including the identifier extracted from the content. The information providing server 2 identifies items used to select one of a plurality of pieces of relevant information to be provided for the user terminal 1 with respect to the content corresponding to the identifier.

That is, in this embodiment, the user terminal 1 extracts the user information from the registered information, and the information providing server 2 identifies item names of the profile and the tastes to be extracted from the registered information. For example, when the item “gender”, the item “age”, and the item “favorite color” have been specified as the condition information, the user information to be used is information regarding “gender”, “age”, and “favorite color”.

Next, the information providing server 2 transmits a user information request to the user terminal 1 (T11). The user information request is information including the extracted item names of the user information. Furthermore, when the items are ones whose values are determined by selecting one of a plurality of candidate values, the user information request may include a plurality of character strings that are associated with the item names and that serve as the candidate values.

For example, when relevant information according to a favorite color of the user, namely, for example, “white” or “black”, is to be provided with respect to the item “favorite color”, the user information request includes candidate values “white, black” along with the item name “favorite color”.

Upon receiving the user information request, the user terminal 1 accesses the web server 3 and makes a registered information request (T12). The web server 3 provides registered information registered using the account of the user of the user terminal 1 for the user terminal 1 (T13). For example, a Hyper Text Markup Language (HTML) document for drawing a screen to be displayed after login is provided as the registered information.

Next, the user terminal 1 generates user information on the basis of the registered information, and provides the user information for the information providing server 2 (T14). The information providing server 2 generates information to be provided including at least one piece of relevant information on the basis of the user information. The information providing server 2 then transmits the generated information to be provided to the user terminal 1 (T15).

As described above, when information is to be provided in accordance with the profile and the tastes of the user, the user might not register user information regarding the profile and the tastes thereof in order to receive information. That is, by utilizing information registered by the user in an SNS website or the like in the past, appropriate information is provided for the user.

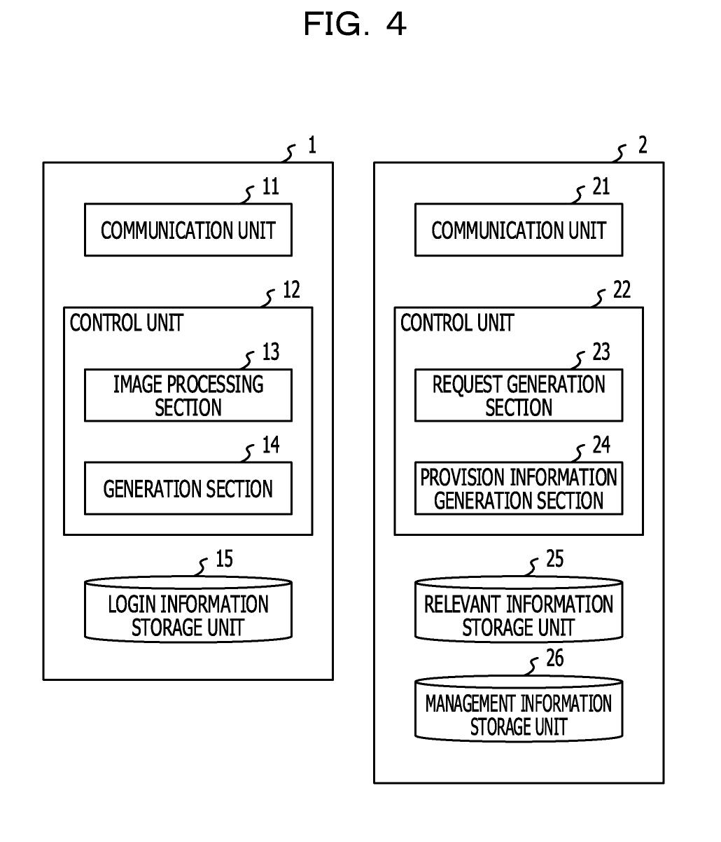

Next, the functional configurations of the user terminal 1, which is the reception device, and the information providing server 2, which is the transmission device, will be described. FIG. 4 is a functional block diagram illustrating the user terminal 1 and the information providing server 2.

The user terminal 1 includes a communication unit 11, a control unit 12, and a login information storage unit 15. The control unit 12 includes an image processing section 13 and a generation section 14. On the other hand, the information providing server 2 includes a communication unit 21, a control unit 22, the relevant information storage unit 25, and a management information storage unit 26. The control unit 22 includes a request generation unit 23 and a provision information generation section 24.

The communication unit 11 of the user terminal 1 is a processing unit that communicates with other devices. For example, the communication unit 11 communicates with the information providing server 2 and the web server 3.

The control unit 12 of the user terminal 1 is a processing unit that controls various types of processing performed by the user terminal 1. The image processing section 13 is a processing section that obtains at least one image of content and that extracts an identifier by analyzing the obtained image. For example, the image processing section 13 activates the camera and obtains an image in accordance with a request from the user. The image processing section 13 then obtains an identifier from the image. Here, as described above, the technique disclosed in Japanese Laid-open Patent Publication No. 2004-349879, Japanese Laid-open Patent Publication No. 2007-67629, or Japanese Laid-open Patent Publication No. 2012-142741 may be used.

The generation section 14 of the user terminal 1 is a processing section that controls access to the web server 3. Furthermore, the generation section 14 is a processing section that generates user information on the basis of the registered information obtained from the web server 3 in accordance with the user information request from the information providing server 2. For example, the user terminal 1 searches the registered information using item names specified in the user information request as keys. The user terminal 1 then obtains character strings described after the item names as the user information. For example, when there is a character string that is the same as the item name “gender” in the HTML document, the user terminal 1 obtains characters or a character string “male” after the character string and generates user information including the item name “gender” and the item value “male”.

When an item name and candidate values have been associated with each other in the user information request, the user terminal 1 searches the registered information using the candidate values as keywords. The user terminal 1 then generates user information in accordance with the number of appearances of each candidate value. For example, the user terminal 1 counts the numbers of appearances of “white” and “black” in the HTML document. Thereafter, the user terminal 1 generates user information including the item name “favorite color” and the item value that is a candidate value whose number of appearances is larger.

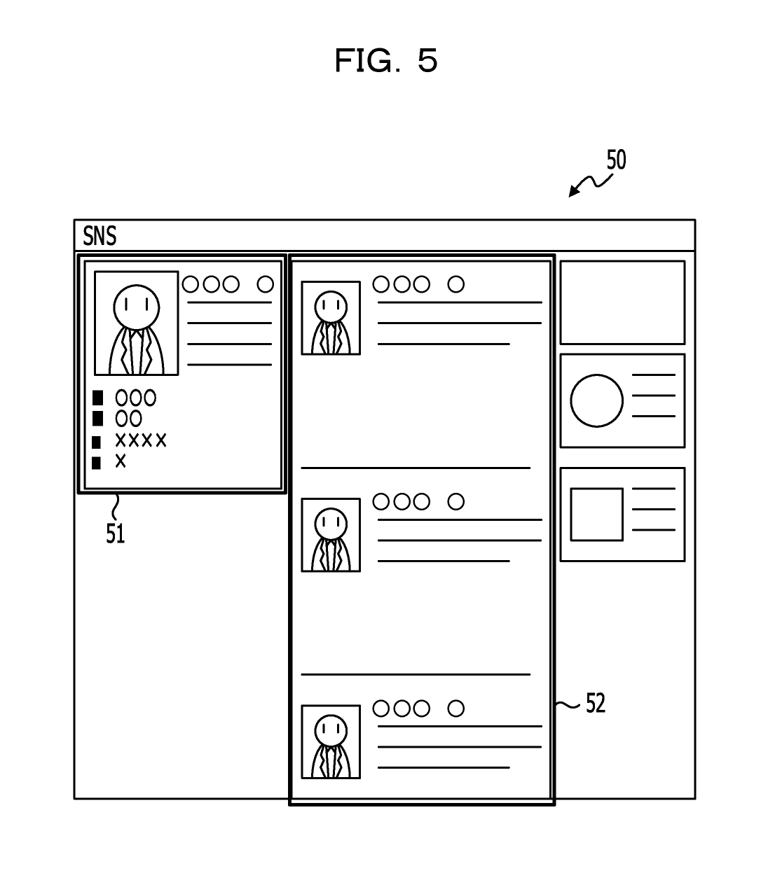

FIG. 5 is a diagram illustrating an image at a time when the registered information is displayed. The generation of user information described above will be described in detail with reference to FIG. 5. FIG. 5 illustrates a screen 50 displayed on the basis of the registered information when the HTML document for drawing a screen to be displayed after login is used as the registered information.

The screen 50 often includes a profile display region 51 and a posted article display region 52 for the user. That is, the registered information includes profile information displayed in the profile display region 51 and posting information regarding posted articles displayed in the posted article display region 52.

Therefore, the generation section 14 obtains the HTML document for drawing a screen to be displayed after login from the web server 3 and generates user information from the registered information. This is because the profile information and the posting information are likely to include information regarding the profile and the tastes of the user. In this embodiment, the registered information obtained from the web server 3 might not be displayed by the user terminal 1, and the registered information may be used only to generate user information.

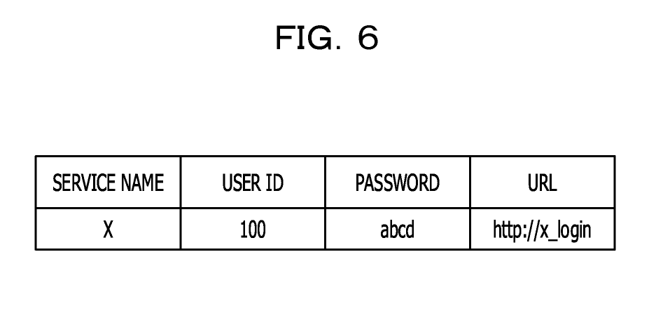

Next, the login information storage unit 15 illustrated in FIG. 4 is a storage unit that stores login information. FIG. 6 is a diagram illustrating an example of the data structure of the login information storage unit 15.

The login information is information including the name of a service, a user identifier (ID), a password, and a URL. The login information storage unit 15 stores the name of a service, a user ID, a password, and a URL while associating these pieces of information with one another. When the user has obtained accounts for a plurality of web services, a plurality of pieces of login information may be stored.

The name of a service is the name of a service provided by the web server 3. The user terminal 1 obtains the registered information by logging in a website that provides the service. The user ID is identification information provided for the user by the service. The password is a password for login specified by the user or the web server 3. The URL is information indicating a URL for login.

Here, the generation section 14 controls the communication unit 11 and accesses the web server 3 using the login information. When an application has been downloaded to the user terminal 1 such as a smartphone, automatic login may be performed. Alternatively, login information included in the application may be used in the login process disclosed in this embodiment.

Next, the communication unit 21 of the information providing server 2 is a processing unit that communicates with other devices. For example, the communication unit 21 communicates with the content processing server 4 and the user terminal 1.

The control unit 22 of the information providing server 2 is a processing unit that controls various types of processing performed by the information providing server 2. The request generation section 23 is a processing section that generates a user information request.

The provision information generation section 24 is a processing section that generates information to be provided on the basis of the information regarding the registered information received from the user terminal 1. In this embodiment, the provision information generation section 24 generates information to be provided for the user on the basis of the user information obtained from the user terminal 1.

More specifically, the provision information generation section 24 selects one of a plurality of pieces of relevant information according to the user information. The provision information generation section 24 then generates information to be provided including the selected piece of relevant information.

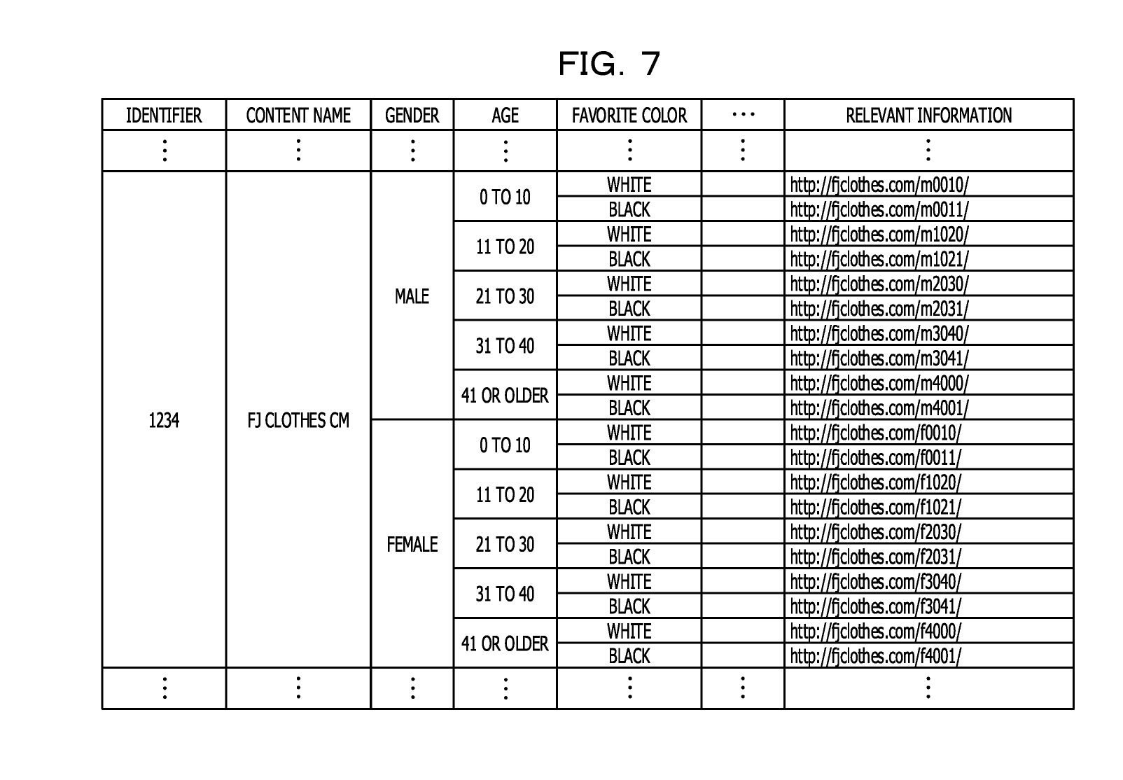

The relevant information storage unit 25 is a storage unit that stores a plurality of relevant information corresponding to content. FIG. 7 is a diagram illustrating an example of the data structure of the relevant information storage unit 25.

The relevant information storage unit 25 stores an identifier, the name of content, items, and relevant information while associating these pieces of information with one another. In the example illustrated in FIG. 7, a plurality of pieces of relevant information “http://fjclothes.com/m0010/”, “http://fjclothes.com/m0011/”, and the like are associated with content “FJ clothes commercial message” whose identifier is “1234”. Each piece of relevant information is uniquely selected on the basis of item values of items included in the user information.

For example, when the user information includes the item value “male” of an item “gender”, the item value “30” of the item “age”, and the item value “black” of the item “favorite color”, the provision information generation section 24 selects the relevant information “http://fjclothes.com/m2031/”. The condition information for uniquely selecting a piece of relevant information and the plurality of pieces of relevant information are input from the advertiser terminal 5 through the content processing server 4.

The manager who is operating the advertiser terminal 5 may set arbitrary condition information for each piece of content. That is, although the item names “gender”, “age”, and “favorite color” are used in the example illustrated in FIG. 7, other item names may be specified in the condition information for another piece of content. When conditions such as the items “gender” and “favorite color” have not been specified in another piece of content, values are not stored for these item names corresponding to this piece of content.

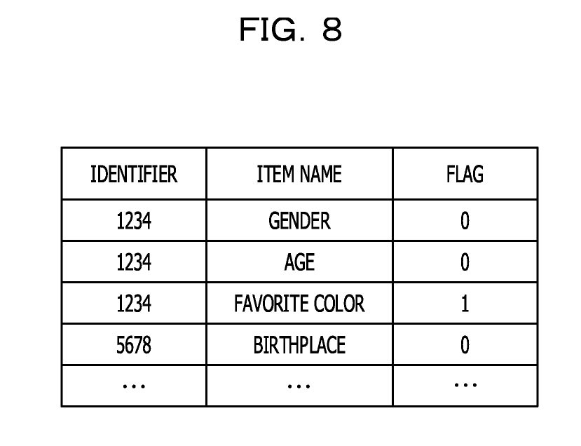

The management information storage unit 26 is a storage unit that stores management information. FIG. 8 is a diagram illustrating an example of the data structure of the management information storage unit 26.

The management information storage unit 26 stores an identifier, an item name, and a flag while associating these pieces of information with one another. The management information is information including an identifier, an item name, and a flag, and is information for determining whether or not to specify candidate values in the user information request. For example, when a request to provide information including a certain identifier has been received from the user terminal 1, the request generation section 23 refers to the management information storage unit 26.

Among specified items corresponding to the identifier, candidate values are not specified in the user information request for an item name whose flag is “0”. On the other hand, for an item name whose flag is “1”, candidate values are specified in the user information request. In the generation of user information, an item value is determined from among the candidate values for an item for which the candidate values have been specified.

For example, when the communication unit 21 has received a request to provide information including the identifier “1234”, the request generation section 23 refers to the management information storage unit 26 and generates a user information request regarding the identifier “1234”. Since the flag for the item name “gender” is “0” in the user information request, the request generation section 23 determines candidate values to be empty or “0”. The same holds true for the item name “age”.

On the other hand, since the flag for the item name “favorite color” is “1”, candidate values are set. When candidate values are to be set, the request generation section 23 refers to the relevant information storage unit 25. The request generation section 23 then obtains values set in the column of the item name “favorite color” of the identifier “1234” as candidate values. For example, in the example illustrated in FIG. 7, “white” and “black” are obtained. The obtained candidate values are associated with the item name and set in the user information request. With respect to the item name whose flag is “1” in the management information storage unit 26 illustrated in FIG. 8, candidate values may be associated and stored in advance.

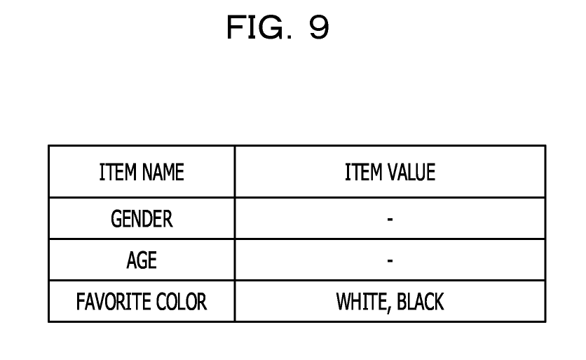

FIG. 9 is a diagram illustrating an example of the data structure of a user information request. The user information request includes information in which item names and candidate values are associated with each other. Furthermore, an identifier of content may be included. FIG. 9 illustrates an example of the user information request in which a combination between the item name “gender” and a candidate value “empty or 0”, a combination between the item name “age” and the candidate value “empty or 0”, and a combination between the item name “favorite color” and the candidate values “white, black” are specified.

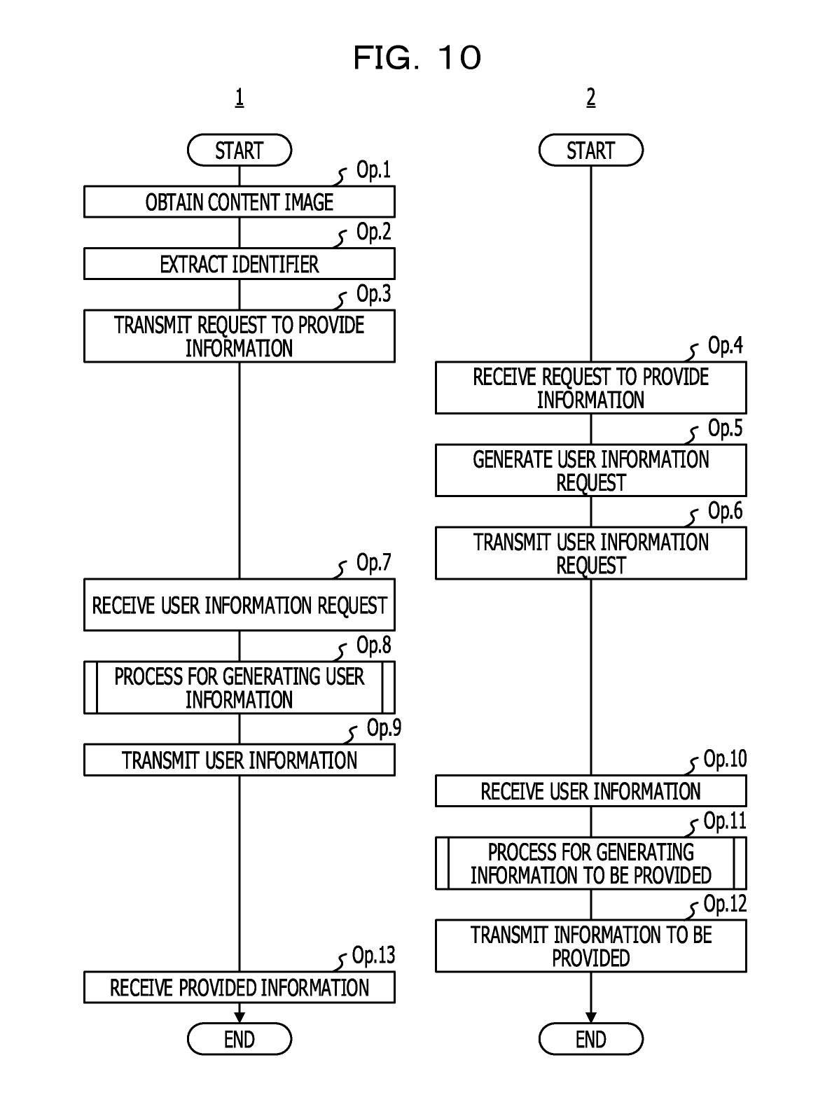

Next, the processing flows of the reception device and the transmission device according to this embodiment will be described. FIG. 10 is a flowchart illustrating a reception process performed by the reception device and a flowchart illustrating a transmission process performed by the transmission device.

First, the image processing section 13 of the user terminal 1 obtains content (Op. 1). For example, the user activates an application for extracting an identifier added to the image, and then captures the image by operating a camera. The image processing section 13 obtains one or a plurality of captured images as content images. The camera is a camera included in a user terminal such as a mobile telephone or a smartphone.

Next, the image processing section 13 extracts an identifier from the obtained content image (Op. 2). Here, information regarding the address of the information providing server 2 may be embedded in the content image along with the identifier. In this case, the address information is extracted along with the identifier. On the other hand, the information regarding the address of the information providing server 2 may be managed by an application installed on the user terminal 1. In this case, a request to provide information, which will be described later, is transmitted to the address managed by the application.

Next, the control unit 12 generates a request to provide information including the extracted identifier. The communication unit 11 transmits the request to provide information to the information providing server 2 under control of the control unit 12 (Op. 3).

The communication unit 21 of the information providing server 2 receives the request to provide information (Op. 4). The request generation section 23 generates a user information request (Op. 5). More specifically, the management information stored in the management information storage unit 26 is obtained using the identifier included in the request to provide information as a key. Furthermore, when there is an item name for which candidate values are to be set, that is, when there is an item name whose flag is “1”, the request generation section 23 refers to the relevant information storage unit 25 and obtains the candidate values. The request generation section 23 generates, for example, the user information request illustrated in FIG. 9.

Next, the communication unit 21 transmits the user information request to the user terminal 1 under control of the control unit 22 (Op. 6). The communication unit 11 of the user terminal 1 receives the user information request (Op. 7). The generation section 14 generates user information on the basis of the user information request (Op. 8). A process for generating user information will be described later.

The communication unit 11 transmits the user information to the information providing server 2 under control of the control unit 12 (Op. 9). Here, the communication unit 11 transmits the identifier extracted in Op. 2 again along with the user information. The communication unit 21 of the information providing server 2 receives the user information and the identifier (Op. 10).

The provision information generation section 24 generates information to be provided (Op. 11). A process for generating information to be provided will be described later. The communication unit 21 transmits the generated information to be provided under control of the control unit 22 (Op. 12).

The communication unit 11 of the user terminal 1 receives the provided information (Op. 13). Here, the user terminal 1 may perform an additional process on the basis of the provided information. For example, when the provided information includes the URL of a particular website, the user terminal 1 accesses the website.

By the above-described process, the information to be provided generated on the basis of the profile and the tastes of the user is provided for the user.

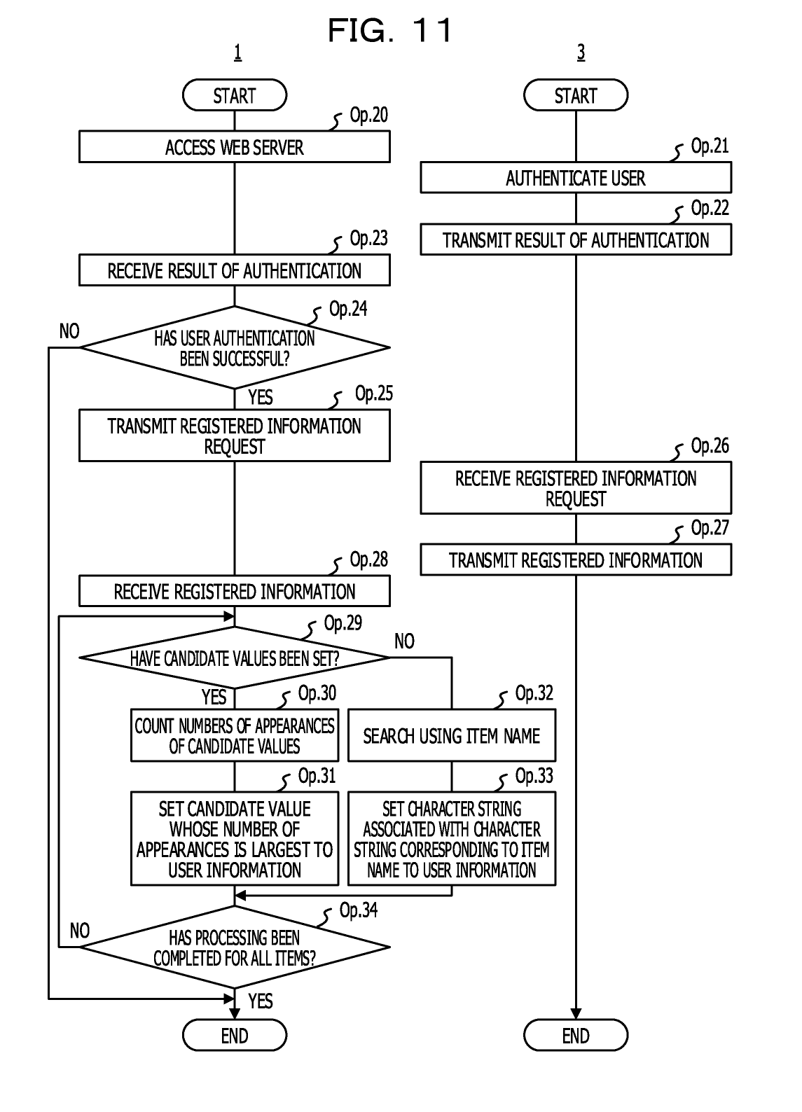

Next, the process for generating user information will be described. FIG. 11 is a flowchart illustrating the process for generating user information. During the process for generating user information performed by the user terminal 1, communication with the web server 3 is performed. Therefore, processing performed by the web server 3 is also illustrated in FIG. 11.

The communication unit 11 accesses the web server 3 under control of the control unit 12 of the user terminal 1 (Op. 20). The generation section 14 included in the control unit 12 obtains login information from the login information storage unit 15. For example, in the example illustrated in FIG. 6, a user ID “100” and a password “abcd” for a service “X” are obtained. Furthermore, a URL “http://x_login” is obtained as the access destination. The communication unit 11 requests the web server 3 to authenticate the user by transmitting the user ID and the password to the access destination.

The web server 3 authenticates the user on the basis of the user ID and the password received from the user terminal 1 (Op. 21). The web server 3 then transmits the result of the authentication to the user terminal 1 (Op. 22). The result of the authentication is information indicating whether or not the authentication of the user has been successful.

The communication unit 11 of the user terminal 1 receives the result of the authentication (Op. 23). The generation section 14 determines whether or not the result of the authentication indicates that the authentication of the user has been successful (Op. 24).

If the authentication of the user has been successful (YES in Op. 24), the communication unit 11 transmits a registered information request to the web server 3 under control of the control unit 12 (Op. 25). For example, the generation section 14 included in the control unit 12 generates a registered information request to request information registered using a user account. The communication unit 11 transmits the registered information request to a particular web server.

The web server 3 receives the registered information request (Op. 26). The web server 3 then obtains registered information corresponding to the user account specified in the registered information request from a storage unit thereof. Thereafter, the web server 3 transmits the obtained registered information to the user terminal 1 in an HTML format (Op. 27).

The communication unit 11 of the user terminal 1 receives the registered information (Op. 28). The generation section 14 determines whether or not candidate values have been set for an item name or each of a plurality of item names set in the user information request (Op. 29).

If candidate values have been set (YES in Op. 29), the generation section 14 searches the registered information using each of the plurality of candidate values as a key. The generation section 14 then counts the number of appearances of each candidate value (Op. 30). A candidate value whose number of appearances is the largest is associated with the item name and set to user information (Op. 31).

That is, because it may be assumed that the candidate value whose number of appearances is the largest in the registered information is information relating to the profile and the tastes of the user, the user information is generated on the basis of the candidate value.

On the other hand, if candidate values have not been set (NO in Op. 29), the generation section 14 searches the registered information using an item name as a keyword (Op. 32). The generation section 14 then obtains another character string associated with a character string corresponding to the item name in the registered information (Op. 33). More specifically, in the case of the registered information in the HTML format, a character string configured to be displayed after the character string corresponding to the item name is obtained. Alternatively, the user information may be generated using an application program interface (API) for disclosing profile information.

Next, the generation section 14 determines whether or not the processing has been completed for all the item names included in the user information request (Op. 34). If the processing has been completed (YES in Op. 34), the generation section 14 determines that the generation of the user information requested by the user information request has been completed, and ends the process for generating user information.

On the other hand, if the processing has not been completed for all the item names (NO in Op. 34), the process returns to Op. 29, and the processing is repeated until the processing is completed for all the item names.

If the authentication of the user has not been successful (NO in Op. 24), the process for generating user information ends. In Op. 9 illustrated in FIG. 10, the communication unit 11 transmits information indicating that user information has not been extracted to the information providing server 2 under control of the control unit 12. Here, if user information has not been extracted, the information providing server 2 may transmit information to be provided including default relevant information to the user terminal 1 (Op. 12).

By the above-described process, the user information is generated from the registered information. That is, the information regarding the profile and the tastes of the user is generated using information registered by the use for using a service provided by the information providing server 2 and information posted by the user. Therefore, the user might not newly register information regarding the profile and the tastes thereof in order to receive information.

Furthermore, factors in selecting information to be provided for the user vary depending on the type of content. For example, in the case of content relating to clothes, information to be provided that is likely to attract the user's attention is generated on the basis of the items “gender”, “age”, and “favorite color”. On the other hand, in the case of content relating to food, information to be provided that is likely to attract the user's attention is generated on the basis of items “gender”, “favorite food”, and “favorite country”.

According to this embodiment, information regarding the profiles and the tastes of a wide variety of users may be generated by utilizing the information registered in the web server 3 so far. Information regarding various profiles and tastes may be generated in accordance with the factors in selecting information to be provided for the users. When the user manually inputs such information, the amount of information to be input might become large, but according to this embodiment, such inconvenience may be avoided.

Furthermore, when the user manually inputs item values for various items in advance and the user terminal 1 stores the item values, a storage region for storing user information regarding various items is used. According to this embodiment, however, the user information is generated on the basis of the registered information, and accordingly user information regarding various items might not be stored in a storage region.

Although an example in which the user terminal 1 generates user information has been described above, the information providing server 2 may generate user information, instead, as described above. More specifically, the user terminal 1 transmits registered information to the information providing server 2 as the information regarding the registered information. The information providing server 2 then executes the processing in Op. 28 to Op. 34 illustrated in FIG. 11.

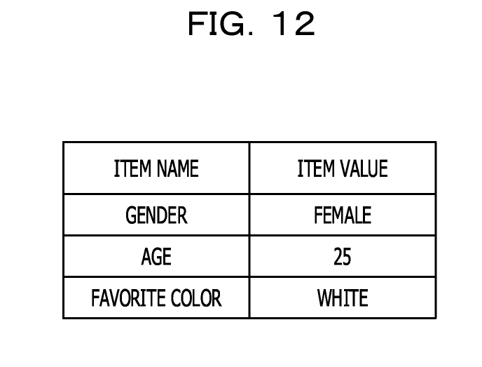

FIG. 12 is a diagram illustrating an example of the user information. In FIG. 12, user information generated when the user information request illustrated in FIG. 9 has been received is illustrated as an example.

The user information is information in which item names and item values are associated with each other. For example, the user information includes a combination between the item name “gender” and the item value “female”, a combination between the item name “age” and an item value “25”, and a combination between the item name “favorite color” and the item value “white”. That is, the user information is information in which item values have been set for the items requested by a user information request such as that illustrated in FIG. 9.

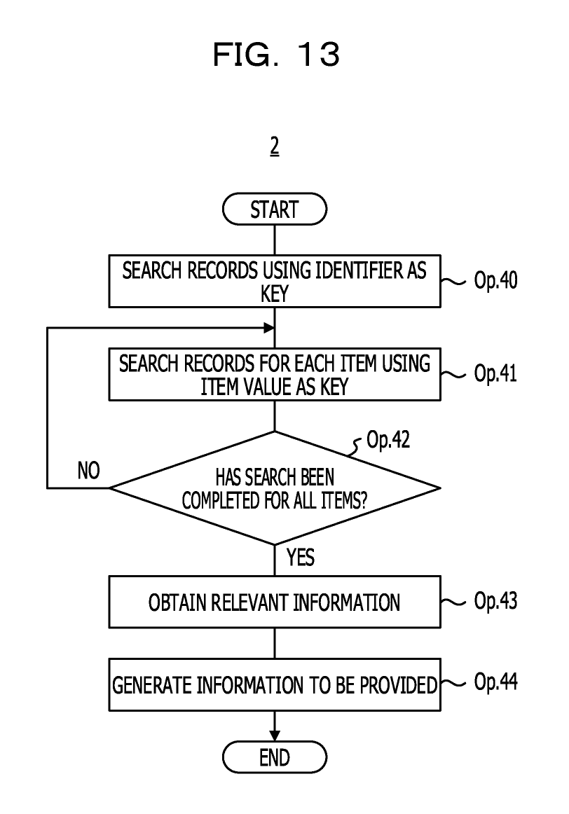

Next, the process for generating information to be provided performed by the information providing server 2 will be described. FIG. 13 is a flowchart illustrating the process for generating information to be provided.

The provision information generation section 24 searches records of the relevant information storage unit 25 using the identifier received along with the user information as a key (Op. 40). Furthermore, the provision information generation section 24 searches the records of the relevant information storage unit 25 on the basis of the item names and the item values included in the user information (Op. 41).

If the search process has been completed for all the items included in the user information (YES in Op. 42), relevant information stored in found records is obtained (Op. 43). For example, the search is sequentially performed from the top of the plurality of items set in the user information request. That is, the search is sequentially performed from the leftmost item in the relevant information storage unit 25 illustrated in FIG. 7.

Next, the provision information generation section 24 generates information to be provided including the obtained relevant information (Op. 44). The information to be provided is information including at least one piece of relevant information. Furthermore, the information to be provided may include the name of content or the name of a provider of relevant information.

By the above-described process, the information to be provided is generated. That is, the information to be provided according to the profile and the tastes of the user is provided for the user. Furthermore, desired user information may be obtained from the user terminal 1 by specifying items for identifying relevant information to be provided for each piece of content in the user information request. Therefore, the information providing server 2 may generate appropriate information to be provided on the basis of the user information including particular items and item values for each piece of content.

### Another Embodiment

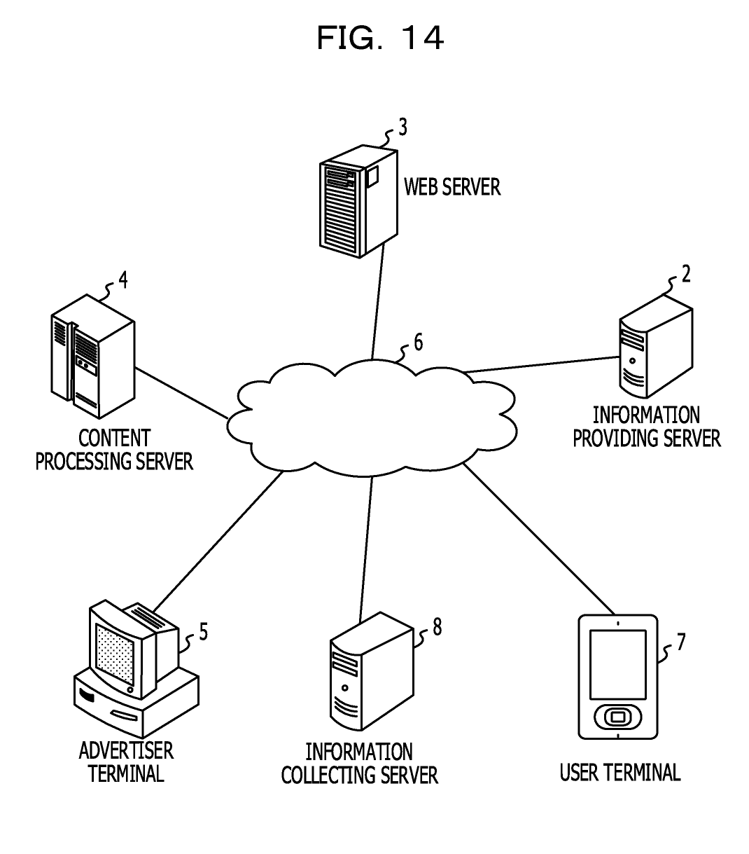

Another embodiment will be described hereinafter. FIG. 14 is a diagram illustrating an information providing system according to this embodiment. The information providing system includes a user terminal 7, which is a reception device, an information providing server 2, which is a transmission device, and an information collecting server 8.

Among the plurality of devices illustrated in FIG. 14, the information providing server 2, a content processing server 4, and an advertiser terminal 5 perform the same processes as those according to the first embodiment.

In this embodiment, the information collecting server 8 collects registered information from the web server 3 and generates user information. The user information is then transmitted to the information providing server 2 through the user terminal 7. Furthermore, the information collecting server 8 manages history information regarding the generation of the user information. The history information will be described later.

That is, the user terminal 7, which is the reception device, receives information regarding the registered information from the information collecting server 8. In this embodiment, the information regarding the registered information is the user information generated by the information collecting server 8.

The user terminal 7 transmits the user information, which is the information regarding the registered information, to the information providing server 2, which is the transmission device. The information providing server 2 generates information to be provided on the basis of the user information and transmits the information to be provided to the user terminal 7. The user terminal 7 receives information by receiving the provided information.

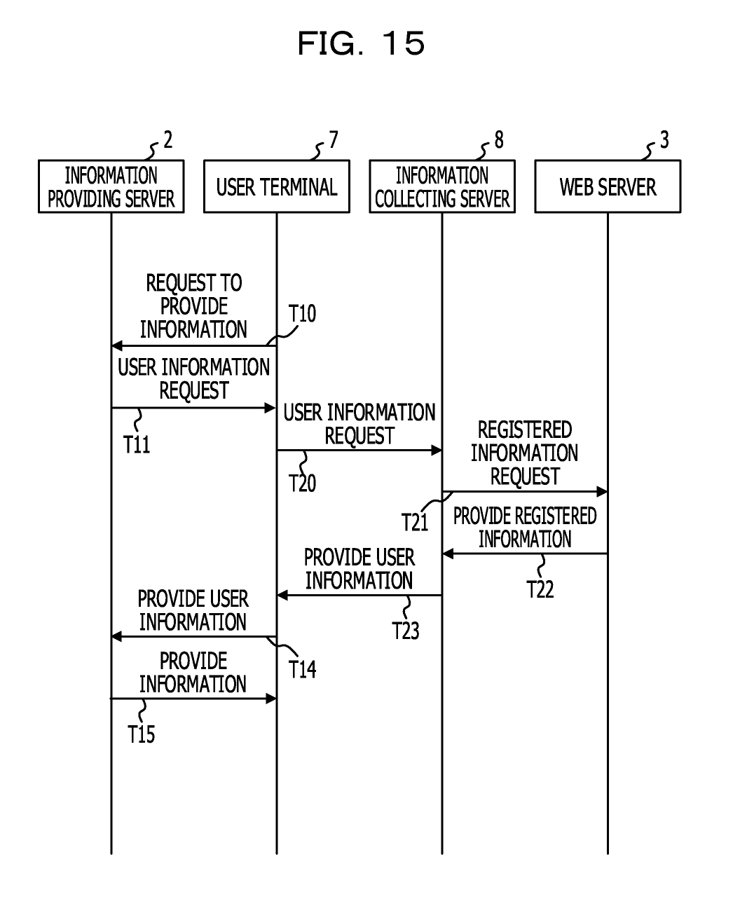

FIG. 15 is a sequence diagram illustrating a procedure beginning with a request to provide information made by the user terminal 7 and ending with transmission of information to be provided to the user terminal 7. T10, T11, T14, and T15 are the same as those illustrated in FIG. 3.

Upon receiving a user information request from the information providing server 2, the user terminal 7 transmits the user information request to the information collecting server 8 (T20). The user terminal 7 also transmits login information to the information collecting server 8.

The information collecting server 8 accesses the web server 3 using the login information and transmits a registered information request (T21). The web server 3 provides registered information for the information collecting server 8 (T22). The information collecting server 8 generates user information on the basis of the registered information and the user information request. The information collecting server 8 then transmits the generated user information to the user terminal 7 (T23).

The user terminal 7 transmits the user information to the information providing server 2 (T14). The subsequent processing is the same as that illustrated in FIG. 3.

The information collecting server 8 stores history information along with a user ID included in the login information. Alternatively, history information may be stored for each terminal ID using a terminal ID for identifying the user terminal 7. In this case, in T20, the user terminal 7 also transmits the terminal ID to the information collecting server 8.

The information collecting server 8 then uses the history information to generate user information. For example, upon receiving the user information request and the login information from the user terminal 7, the information collecting server 8 determines whether or not history information corresponding to the user ID of a user of the user terminal 7 is stored in a history information storage unit 84 thereof. If the history information is stored, the history information is used to generate user information. Details will be described later.

User information regarding the profile and the tastes of a user is expected to change. Therefore, the information collecting server 8 may generate user information using history information generated in a certain period preceding a time at which the user information is generated.

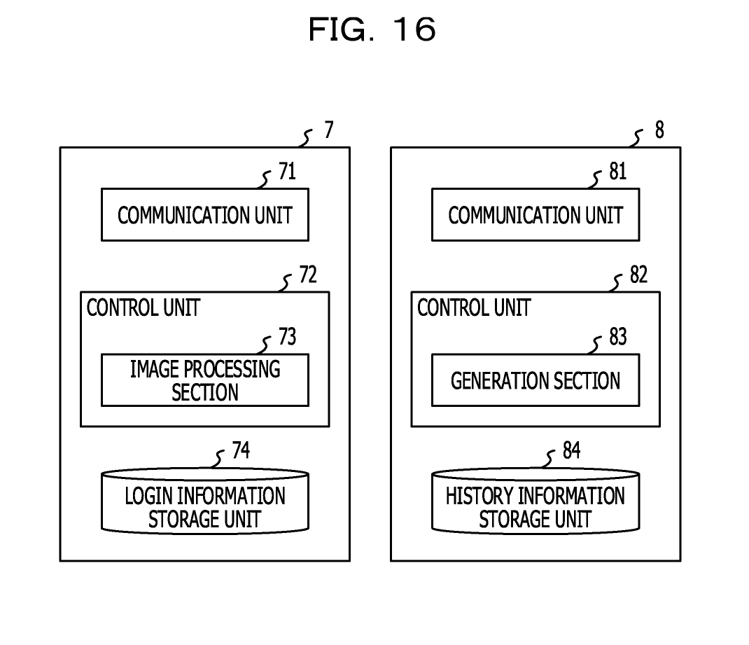

Next, the functional configuration of the user terminal 7 and the information collecting server 8 according to this embodiment will be described. FIG. 16 is functional block diagrams illustrating the user terminal 7 and the information collecting server 8. The functional configurations of the information providing server 2 and the like are the same as those according to the first embodiment.

The user terminal 7 includes a communication unit 71, a control unit 72, and a login information storage unit 74. The control unit 72 includes an image processing section 73. On the other hand, the information collecting server 8 includes a communication unit 81, a control unit 82, and the history information storage unit 84. The control unit 82 includes a generation section 83.

The communication unit 71 of the user terminal 7 is a processing unit that communicates with other devices. For example, the communication unit 71 communicates with the information providing server 2 and the information collecting server 8.

The control unit 72 controls various types of processing performed by the user terminal 7. For example, when a user information request has been received, the control unit 72 controls the communication unit 71 such that the communication unit 71 transmits login information and the user information request to the information collecting server 8. Therefore, the control unit 72 controls access to the web server 3 through the information collecting server 8. The image processing section 73 performs the same process as that performed by the image processing section 13 according to the first embodiment.

The login information storage unit 74 is a storage unit that stores login information. The data structure of the login information storage unit 74 is the same as that of the login information storage unit 15 according to the first embodiment.

The communication unit 81 of the information collecting server 8 is a communication unit that communicates with other devices. For example, the communication unit 81 communicates with the user terminal 7 and the web server 3.

The generation section 83 controls various types of processing performed by the information collecting server 8. The generation section 83 accesses the web server 3 through the communication unit 81 on the basis of the login information. In addition, the generation section 83 generates user information on the basis of a user information request and registered information. Furthermore, the generation section 83 uses history information to generate the user information.

The history information storage unit 84 stores history information. The history information storage unit 84 is a storage unit that stores a user ID and history information while associating the user ID and the history information with each other. The history information is information including an item name, an item value, a candidate value, and the number of appearances. The history information storage unit 84 may further store the date of update of the history information.

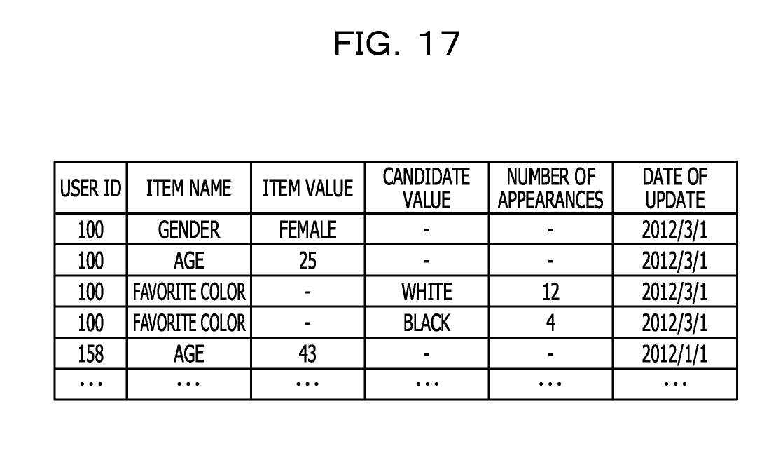

FIG. 17 illustrates an example of the data structure of the history information storage unit 84. The history information storage unit 84 stores a user ID, an item name, an item value, a candidate value, the number of appearances, and the date of update while associating these pieces of information with one another. The item name is an item name included in user information generated in the past. In the item value column, an item value included in user information generated in the past is stored. However, an item value is stored only for an item for which candidate values have not been set in a user information request.

In the candidate value column, a candidate value is associated with an item name and stored for an item for which candidate values have been set in a user information request. Furthermore, in the number of appearances column, the number of appearances of each candidate value counted during generation of user information is stored. With respect to an item for which candidate values have been set in a user information request, an item value is not stored.

The date of update is information regarding the date of update on which any piece of information in the record has been updated. For example, when an item value or the number of appearances has been updated, information regarding the date of the update is stored.

Assume that, upon receiving the user information request illustrated in FIG. 9 from the user terminal 7, the information collecting server 8 has generated the user information illustrated in FIG. 12 in accordance with the user information request. In this case, since no candidate values have been set for the item name “gender”, the information collecting server 8 stores the item value “female” in the item value column of the history information storage unit 84 while associating the item value with the item name “gender”. The same holds true for the item name “age”.

On the other hand, candidate values have been set for the item name “favorite color” in the user information request. Therefore, the generation section 83 associates the candidate values “white” and “black” set as the candidate values with the item name “favorite color”, and sets the candidate values in the candidate value column of the history information storage unit 84. Next, as in the first embodiment, the result of count of the number of appearances of each candidate value during generation of user information is stored as the “number of appearances”.

When an item name specified in a user information request exists in the history information storage unit 84 and candidate values have not been set in the user information request, the generation section 83 obtains an item value corresponding to the item name from the history information storage unit 84. The generation section 83 then generates user information including the item name and the item value.

On the other hand, when an item name specified in a user information request exists in the history information storage unit 84 and candidate values have been set, the generation section 83 determines an item value from the candidate values using the number of appearances of each candidate value.

However, with respect to one of the plurality of candidate values for which the same candidate value is not stored in the history information storage unit 84, the generation section 83 counts the number of appearances using the registered information obtained from the web server 3. The generation section 83 then generates user information including a candidate value whose number of appearances is the largest among the numbers of appearances of the candidate values as an item value.

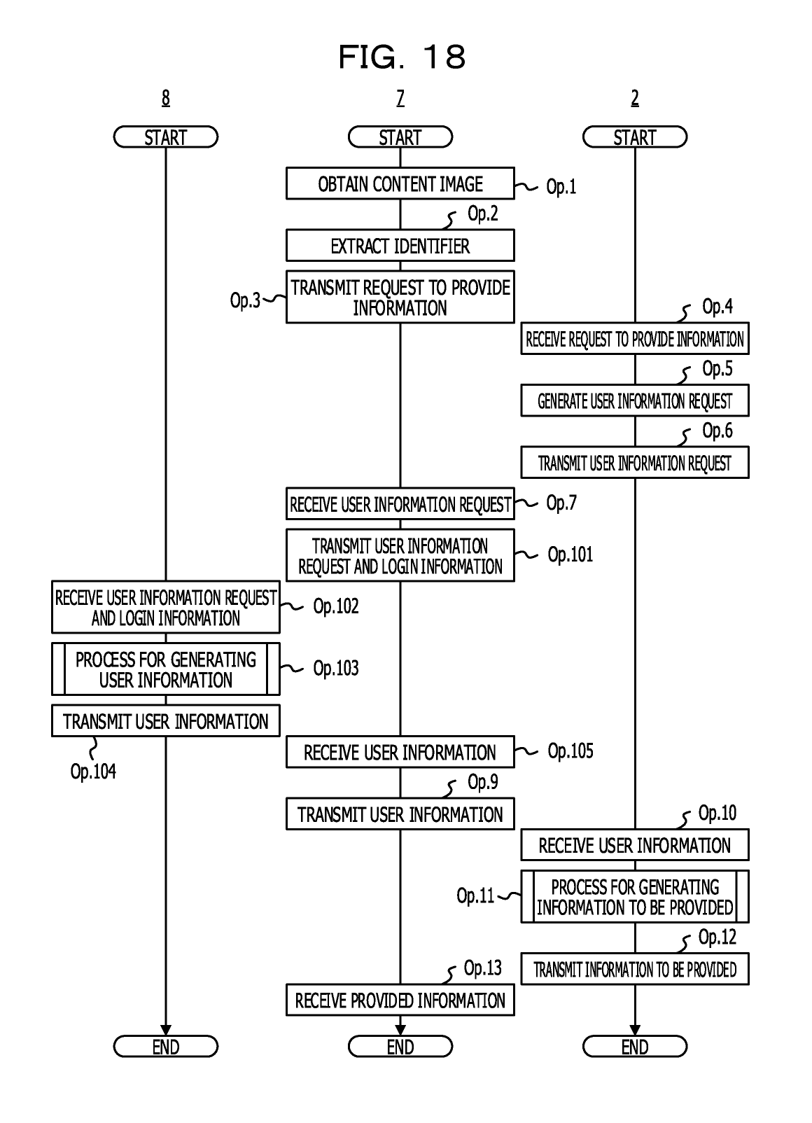

Next, a transmission process performed by the information providing server 2, which is the transmission device, a reception process performed by the user terminal 7, which is the reception device, and a processing flow of the information providing server 2 will be described. FIG. 18 is flowcharts illustrating the transmission process performed by the transmission device, the reception process performed by the reception device, and the processing performed by the information providing server 2 according to this embodiment.

In FIG. 18, processing having the same content as that illustrated in FIG. 10 is given the same reference numerals. When the user information request has been received from the information providing server 2 (Op. 7), the communication unit 71 of the user terminal 7 transmits the user information request and login information to the information collecting server 8 under control of the control unit 72 (Op. 101).

The communication unit 81 of the information collecting server 8 receives the user information request and the login information (Op. 102). Next, the generation section 83 of the information collecting server 8 generates user information (Op. 103). Details will be described later.

Next, the communication unit 81 transmits the generated user information to the user terminal 7 under control of the control unit 82 (Op. 104). The communication unit 71 of the user terminal 7 receives the user information (Op. 105). The communication unit 71 then transmits the received user information to the information providing server 2 (Op. 9). The subsequent processing is the same as that according to the first embodiment.

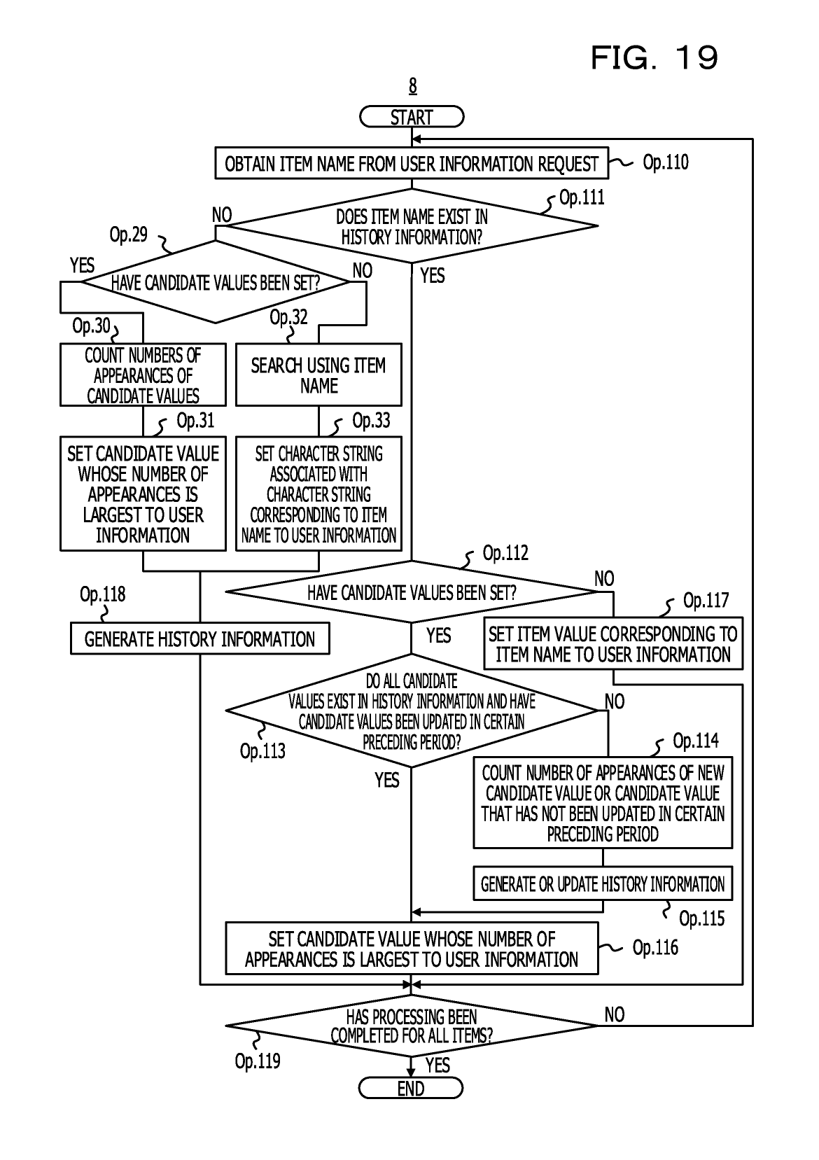

Here, a process for generating user information according to this embodiment will be described. FIG. 19 is a flowchart illustrating the process for generating user information according to this embodiment.

First, the information collecting server 8 performs the processing in Op. 20, Op. 23, Op. 24, Op. 25, and Op. 28 illustrated in FIG. 11 using the login information. That is, the information collecting server 8 accesses the web server 3 and receives the registered information. Next, the information providing server 2 executes the processing in Op. 110 illustrated in FIG. 19.

The generation section 83 obtains one of the item names included in the user information request (Op. 110). The generation section 83 refers to the history information storage unit 84 and determines whether or not the obtained item name is associated with a user ID included in the login information and stored in the history information storage unit 84 (Op. 111).

For example, when the item name obtained from the user information request is “gender” and the history information storage unit 84 stores the history information illustrated in FIG. 9, the generation section 83 determines that the item name is stored.

Here, if the item name is not stored (NO in Op. 111), the generation section 83 performs processing in Op. 29 to Op. 33. The processing in Op. 29 to Op. 33 is the same as that according to the first embodiment described with reference to FIG. 11.

After executing the processing in Op. 29 to Op. 33, the generation section 83 generates new history information on the basis of the generated user information (Op. 118). The generation section 83 then stores the generated history information in the history information storage unit 84 along with the user ID and the date of update.

That is, if the result of Op. 29 is positive, the generation section 83 stores history information including candidate values and the numbers of appearances of the candidate values in the history information storage unit 84. On the other hand, if the result of Op. 29 is negative, the generation section 83 stores history information including item names and item values included in the generated user information in the history information storage unit 84.

On the other hand, if the item name is stored in the history information (YES in Op. 111), the generation section 83 refers to the user information request and determines whether or not candidate values have been associated with the obtained item name and set in the user information request (Op. 112). If candidate values have been set (YES in Op. 112), the generation section 83 determines whether or not all the candidate values set in the user information request exist in the history information and history information regarding all the candidate values is information updated in a certain preceding period (Op. 113).

For example, assume that the item name “favorite color” and the candidate values “white, black” have been set in the user information request, and the date of processing is May 1, 2012. Furthermore, assume that history information updated in the past three months is regarded as valid. In this case, it is determined that all the candidate values exist in the history information storage unit 84 illustrated in FIG. 17 and all pieces of history information have been updated in the certain preceding period.

On the other hand, when the item name “favorite color” and candidate values “white, green” have been set in the user information request, it is determined that not all the candidate values exist in the history information storage unit 84 illustrated in FIG. 17.

If all the candidate values exist in the history information and updated in a certain preceding period (YES in Op. 113), the generation section 83 generates user information including one of the candidate values whose number of appearances is the largest as an item value (Op. 116). For example, when the item name “favorite color” and the candidate values “white, black” have been set in the user information request, the generation section 83 refers to the history information storage unit 84 and generates user information in which the item value “white” is set for the item name “favorite color”.

If not all the candidate values exist in the history information or if there is a candidate value that has not been updated in a certain preceding period (NO in Op. 113), the generation section 83 counts the number of appearances of the candidate value that does not exist in the history information or the candidate value that has not been updated in the certain preceding period (Op. 114). For example, when the item name “favorite color” and the candidate values “white, green” have been set in the user information request, the generation section 83 counts the number of appearances of the candidate value “green”, which does not exist in the history information.

Next, the generation section 83 generates or updates the history information on the basis of each candidate value and the number of appearances of each candidate value (Op. 115). For example, with respect to a candidate value that does not exist in the history information, the generation section 83 generates a new record including an item name, the candidate value, and the number of appearances in the history information storage unit 84. In addition, with respect to a candidate value that has not been updated in the certain preceding period, the generation section 83 updates the candidate value using the newly counted number of appearances. The date of update is also stored. Thereafter, the generation section 83 executes Op. 116.

On the other hand, if candidate values have not been set for the obtained item (NO in Op. 112), the generation section 83 refers to the history information storage unit 84 and generates user information in which an item value corresponding to the item name is set (Op. 117).

For example, when the item name “gender” has been obtained in Op. 110, the generation section 83 obtains the item value “female” corresponding to the item name “gender” from the history information storage unit 84 illustrated in FIG. 17. The generation section 83 then generates user information in which the item name “gender” and the item value “female” are set. With respect to an item for which candidate values have not been set, whether or not to adopt the item may be determined on the basis of the date of update.

Next, the generation section 83 determines whether or not the process for generating user information has been completed for all the items specified in the user information request (Op. 119). If the process has not been completed (NO in Op. 119), the generation section 83 returns to Op. 110.

On the other hand, if the process for generating user information has been completed for all the items (YES in Op. 119), the process for generating user information according to this embodiment ends.

As described above, the generation section 83 stores history information regarding generation of user information for each user. Therefore, in the process for generating user information, the amount of calculation may be reduced by using the history information. In addition, since the user information is generated by the information collecting server 8, processing loads on the user terminal 7 may be reduced.

In addition, since the information regarding the tastes of the user is expected to change over time, history information that has not been updated in a certain preceding period is not used to generate user information. In doing so, user information that reflects the tastes of the user more accurately may be generated. With respect to information that changes over time, such as the age, history information may be updated at certain time intervals.

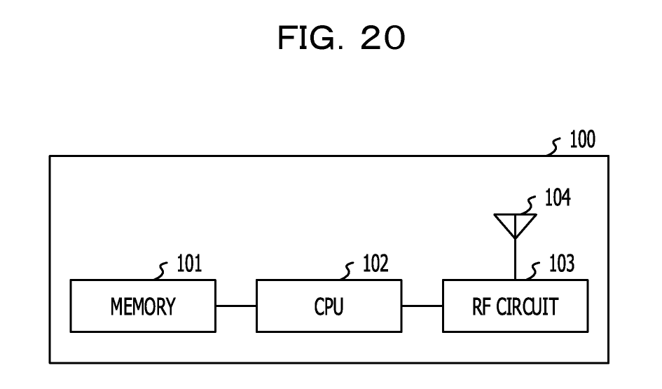

Next, the hardware configuration of a wireless terminal 100 that functions as the user terminal 1 or the user terminal 7 will be described. FIG. 20 is a diagram illustrating the hardware configuration of the wireless terminal 100 that functions as a reception device. As illustrated in FIG. 20, the wireless terminal 100 is a computer that includes, for example, a radio frequency (RF) circuit 103 including an antenna 104, a central processing unit (CPU) 102, and a memory 101 as the component of hardware.

The wireless terminal 100 may further include a display device such as a liquid crystal display (LCD) connected to the CPU 102. The wireless terminal 100 may further include an image pickup device such as a camera connected to the CPU 102.

The memory 101 includes, for example, a least a random-access memory (RAM) such as a synchronous dynamic random-access memory (SDRAM), a read-only memory (ROM), or a flash memory, and stores programs and various pieces of data. For example, the memory 101 stores login information. Furthermore, the memory 101 stores a program in which the reception process is described and a program for extracting information added to content. In the first embodiment, the process for generating user information, which is part of the reception process, is included.

The communication unit 11 and the communication unit 71 are realized by, for example, the antenna 104 and the RF circuit 103. The control unit 12 and the control unit 72 are realized by, for example, an integrated circuit such as the CPU 102.

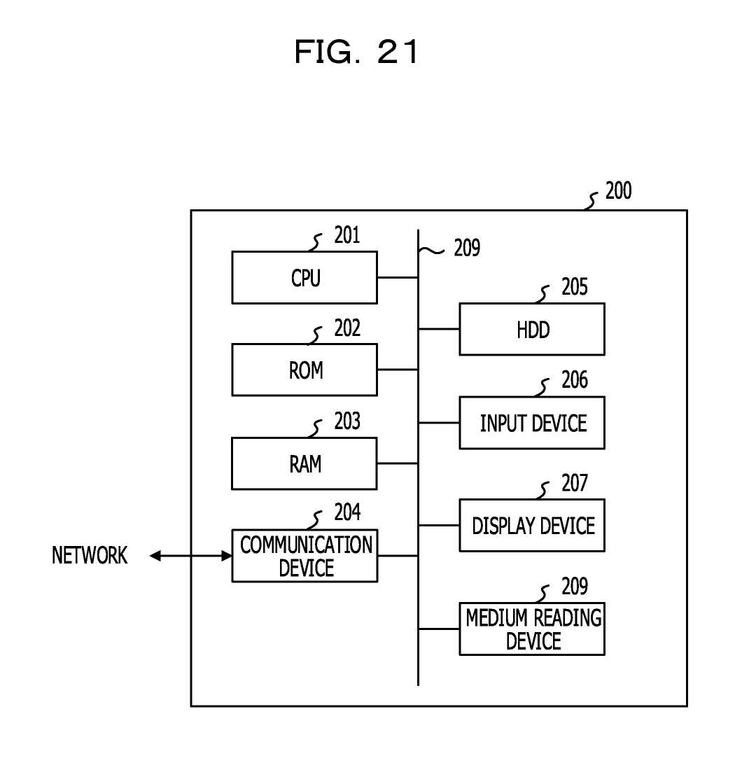

Next, the hardware configuration of a computer 200 that functions as the information providing server 2 or the information collecting server 8 will be described. FIG. 21 is a diagram illustrating an example of the hardware configuration of the computer 200 that functions as a transmission device or the information collecting server 8.

The computer 200 includes a CPU 201, a ROM 202, a RAM 203, a communication device 204, a hard disk drive (HDD) 205, an input device 206, a display device 207, and a medium reading device 209, which are connected to one another through a bus 208. These components may transmit and receive data to and from one another under control of the CPU 201.

When the computer 200 functions as the information providing server 2, a program regarding the transmission process is recorded on a computer-readable recording medium. When the computer 200 functions as the information collecting server 8, a program regarding the process for generating user information is recorded on a computer-readable recording medium.

The computer-readable recording medium may be a magnetic recording device, an optical disk, a magneto-optical recording medium, a semiconductor memory, or the like. The magnetic recording device may be an HDD, a flexible disk (FD), a magnetic tape (MT), or the like. In addition, programs regarding various processes described in the embodiments are recorded on the computer-readable recording medium.

The optical disk may be a digital versatile disc (DVD), a DVD-RAM, a compact disc read-only memory (CD-ROM), a CD-recordable (CD-R), a CD-rewritable (CD-RW), or the like. The magneto-optical recording medium may be a magneto-optical (MO) disk or the like. When the programs are to be distributed, for example, portable recording media such as DVDs or CD-ROMs on which the programs are recorded are sold.

In the computer 200, for example, the medium reading device 209 reads the programs from a recording medium on which the programs are recorded. The CPU 201 stores the read programs in the HDD 205, the ROM 202, or the RAM 203.

The CPU 201 is a central processing unit that controls the entire operation of the computer 200. The HDD 205 stores, for example, programs for causing the computer 200 to execute the processes illustrated in FIGS. 10, 13, 18 and 19 as programs for causing the computer 200 to function as the information providing server 2 and the information collecting server 8 described in the above embodiments.

By reading the programs from the HDD 205 and executing the programs, the CPU 201 functions as various processing units. Alternatively, various programs may be stored in the ROM 202 or the RAM 203 that may be accessed by the CPU 201.

Furthermore, the HDD 205 functions as various storage units under control of the CPU 201. As with the programs, information stored in the storage units may be stored in the ROM 202 or the RAM 203 that may be accessed by the CPU 201, instead. The ROM 202 or the RAM 203 also stores information temporarily generated during the processes.

The display device 207 displays various screens. The communication device 204 receives signals from other devices through a network, and transmits the content of the signals to the CPU 201. Furthermore, the communication device 204 transmits signals to other devices though the network in accordance with instructions from the CPU 201. The communication device 204 functions as the communication unit 21 of the information providing server 2 or the communication unit 81 of the information collecting server 8. The input device 206 receives input of information from the user.

Modifications of the above embodiments will be described hereinafter.

(First Modification)

In a user information request, items for which candidate values have not been set are often items regarding the profile such as age, gender, and birthplace. On the other hand, items for which candidate values have been set are often items regarding the tastes such as favorite color and favorite food.

In an HTML document, it is expected that profile information and posting information are described in such a way as to be distinguished from each other. For example, when an HTML document for drawing the screen including the profile display region 51 and the posted article display region 52 illustrated in FIG. 5 is to be used as registered information, the profile information and the posting information may be distinguished from each other.

Therefore, when such an HTML document has been obtained as registered information, the user terminal 1 or the information collecting server 8 may extract item values for the items regarding the profile from the profile information in the process for generating user information. On the other hand, the user terminal 1 or the information collecting server 8 may extract item values for the items regarding the tastes from the posting information.

(Second Modification)

When registered information is described such that the profile information and the posting information may be distinguished from each other, the user terminal 1 or the information collecting server 8 may generate user information on the basis of the number of appearances of each candidate value corresponding to an item name specified in a user information request in the profile information and the number of appearances of each candidate value corresponding to an item name specified in the user information request in the posting information.

For example, assume that the candidate value “white” appears once in the profile information and five times in the posting information. In this case, the user terminal 1 or the information collecting server 8 calculates the weighted number of appearances using the following expression.

A×(Number of appearances in profile information)+B×(Number of appearances in posting information)=(Weighted number of appearances)

Here, A and B are weighting coefficients, and may be set by the manager. For example, when candidate values are described in the profile information, it may be estimated that the user is interested in the candidate values, and therefore A may be set to a value larger than B. A candidate value to be set as an item value in the user information is then determined from the plurality of candidate values on the basis of the weighted number of appearances.

(Third Modification)

In the above embodiments, user information is generated by searching the registered information using an item name or a candidate value as a key. However, the technique disclosed herein is not limited to this, and, for example, the user information regarding the profile and the tastes may be generated from the registered information using the following methods.

For example, the user terminal 1 or the information collecting server 8 may use a method in which the registered information is analyzed and the gender of the user is determined on the basis of the writing style (Daisuke Ikeda, et al. “Estimation of Gender of Writer of Blog”, Twelfth Annual Meeting of Association for Natural Language Processing, 2006).

Alternatively, the user terminal 1 or the information collecting server 8 may use a method in which the registered information is analyzed and information regarding evaluation of something is extracted on the basis of the structural characteristics of language (Hideyuki Hatakeyama “A Proposal of Sightseeing Reputation Information Extraction Method for Weblog”, Kochi University of Technology, Frontier Technology Course, 2010). That is, the user terminal 1 or the information collecting server 8 may adopt information with which the user has a good reputation as user information.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. An information providing system comprising:
a first device including a first memory and a first processor coupled to the first memory and configured to:
transmit information regarding registered information registered in a server using user identification information for identifying a user, and
receive information to be provided; and
a second device including a second memory and a second processor coupled to the second memory and configured to:
generate the information to be provided on the basis of the information regarding the registered information received from the first device, and
transmit the information to be provided to the first device.

2. The information providing system according to claim 1,
wherein the first processor is further configured to generate user information regarding the user on the basis of the registered information obtained from the server, and
wherein the information regarding the registered information includes the user information.

3. The information providing system according to claim 2,
wherein the user information includes a plurality of items,
wherein the second processor is further configured to generate a request in which the plurality of items used to generate the information to be provided are specified, and transmit the request,
wherein the first processor is further configured to receive the request from the second device, determine an item value for each of the plurality of items specified in the request and generate the user information in which the item values have been set.

4. A reception device comprising:
a memory; and
a processor coupled to the memory and configured to:
transmit, to another device, information regarding registered information registered in a server using user identification information for identifying a user, and
receive, from the other device, information to be provided generated on the basis of the information regarding the registered information.

5. The reception device according to claim 4, wherein the processor is
further configured to generate user information regarding the user on
the basis of the registered information obtained from the server, and
wherein the information regarding the registered information includes the user information.

6. The reception device according to claim 5,
wherein the user information includes a plurality of items, and
wherein the processor is further configured to receive a request in which the plurality of items used to generate the information to be provided are specified, determine an item value for each of the plurality of items specified in the request on the basis of the registered information, and generate the user information in which the item values have been set.

7. The reception device according to claim 6,
wherein at least part of the plurality of items is associated with a plurality of candidate values for an item value for the part of the plurality of items and set in the request, and
wherein the processor is further configured to count the number of appearances of each of the plurality of candidate values in the registered information, determine an item value from the plurality of candidate values on the basis of the numbers of appearances, and generate the user information including the determined item value.

8. The reception device according to claim 5,
wherein the processor is further configured to obtain an image and extracts an identifier for identifying the image from the image, and transmit, to the other device, an provision information request that includes the identifier and that requests transmission of the information to be provided regarding the image.

9. The reception device according to claim 4,
wherein the processor is further configured to receive, from the server, the registered information including profile information regarding a profile registered by the user and posting information regarding an article posted by the user.

10. A method for providing information executed by a computer, the method comprising:
receiving information regarding registered information registered in a server using user identification information for identifying a user;
generating information to be provided for another computer on the basis of the information regarding the registered information; and
transmitting the information to be provided to the other computer.

11. The method according to claim 10,
wherein the information regarding the registered information includes user information regarding the user of the other device, and
wherein, in the generating, the information to be provided according to the user is generated on the basis of the received user information.

12. The method according to claim 11,
wherein the user information includes a plurality of items,
the method further comprising:
transmitting, to the other computer, a request in which the plurality of items used to generate the information to be provided are specified; and
receiving, from the other computer, the user information in which an item value has been set for each of the plurality of items.
